(19) United States
(12) Patent Application Publication
(10) Pub. No.: US 2010/0132017 A1
(43) Pub. Date: May 27, 2010

(54) PROCESS FOR AUTHENTICATING A USER BY CERTIFICATE USING AN OUT-OF BAND MESSAGE EXCHANGE

(75) Inventors: Richard Robinson, Broomfield, CO (US); Prem Sumetpong, Hazlet, NJ (US); Terry Schmalzried, Morganville, NJ (US); Shabbir Khakoo, Morganville, NJ (US); Rodney Finnegan, Broomfield, CO (US)

Correspondence Address: SHERIDAN ROSS PC, 1560 BROADWAY, SUITE 1200, DENVER, CO, 80202, US

(73) Assignee: AVAYA, INC., Basking Ridge, NJ (US)

(21) Appl. No.: 12/275,424

(22) Filed: Nov. 21, 2008

(51) Int. Cl. G06F 21/00

(52) U.S. Cl. 726/5

(57) ABSTRACT

A process for authenticating a user by certificate using an out-of-band message exchange is provided. The authentication of the user may be performed in addition to initial authentication procedures. The certificate-based authentication of the user may provide for a more secure mechanism for confirming the identity of the user and may be used for specific applications requiring such higher security provisions.

### FIELD

The present invention is directed generally to security mechanisms and more particularly to enhanced mechanisms for providing a two factor authentication of a user.

### BACKGROUND

Given the cost associated with purchasing and running computer-based applications on-site, more and more applications are being provided and operated by remote computers/servers (i.e., remote processing devices). These remote processing devices are used to remotely provide a single application to a number of different customers, so that costs associated with the application and the processing device operating the application can be split among the various customers. Remote processing devices and the applications they support may also be used by a single customer that has a distributed enterprise.

Security of the remote processing device and applications provided thereby may be a large concern to the customer, especially if the application utilizes or provides access to sensitive data (e.g., account information, identification information, etc.). User access to the remote processing device is usually gained by providing the remote processing device with a simple username/password (e.g., Telnet, File-Transfer Protocol (FTP), or Secure Shell (SSH)). Thus, only a single, and relatively simple, level of authentication is required of the user to gain access to the remote processing device.

One problem associated with this simple security mechanism is that as applications are added to the remote processing device, the security desired for such applications may differ from the security provisions currently in place for the remote processing device. Moreover, the security desired for the newly added application may differ from the security requirements of already existing applications running on the remote processing device.

When such applications are added to the remote processing device, the overall security of the remote processing device is increased to support the increased security requirements of the newly added application. The normal method for ensuring that users cannot use the remote processing device unless they meet the enhanced security features (e.g., the user employs a two-factor form of authentication) is to implement a restriction on the remote processing device whereby they cannot even logon to the remote processing device unless they are two-factor authenticated. Specific implementation might require SSH and a user certificate to be used for authentication (something which is a configurable feature of SSH, but is not an option for Telnet or FTP). These additional burdens associated with securing the remote processing device are unfortunately applied to other applications that may not necessarily need such security measures. Additionally, users that would otherwise be allowed to access the other less-secure applications are precluded from accessing such applications because the remote processing device is supporting one application that requires a higher level of security.

### SUMMARY

It is thus one aspect of the present invention to address these and other deficiencies of the prior art. More specifically, it is an aim of the present invention to provide an authentication mechanism that helps support different applications that may require different security provisions even when such applications are provided on a common processing device, such as a server.

In accordance with at least one embodiment of the present invention, a method is provided that generally comprises:

establishing a first communication channel between a server and a user device;

performing a first authentication of the user device at the server;

in response to performing the first authentication, allowing the user device to access general functionality of the server;

receiving a request from the user device to access an application on the server;

creating a second communication channel between the server and the user device; and

sending a second authentication request to the user device via the second communication channel.

As used herein, an authentication request is any message which specifically requests the irrefutable confirmation of the identity of the person or thing being requested. The message could contain a random number also known as a challenge which must be logically, mathematically, or cryptographically modified and returned in a response in a manner which can only be performed by the user or device who receives the authentication request. Alternatively the authentication request could contain the description of specifically requested information which only the receiving user or device would know. This could be a username, password, hash of password, other shared secret, or calculated result.

This proposed solution helps ensure that the second application (e.g., a higher security application) cannot process any request for usage without a higher level of authentication (e.g., two-factor authentication of the user), even though the user has not initially used two-factor authentication methods to logon to and utilize the server. More specifically, general access to the server may be controlled with traditional username and password information and does not require the heightened authentication that requires the user to prove they possess a valid thing in addition to knowing something.

This concept not only applies to the user directly accessing the remote server by means of a weak authentication process (e.g., username and password), but is also applicable to the scenario where there exists an intermediate application, such as a front-end web server which may or may not require weak authentication, but does eventually trigger the execution of a back-end application which can only be executed after two-factor authentication of the user.

Most existing solutions require authentication by certificate to be performed in-band as part of the logon process. These application implement a protocol to exchange certificates and the necessary messages to authenticate a user by their certificate. The problem presumes that the software application used to logon to the server, the server itself, or the protocols between the user device and server do not support certificate-based authentication. This raises the need for an out-of-band method of authentication. More specifically, an out-of-band method of performing authentication in addition to the original authentication required to access the server. As can be appreciated, however, embodiments of the present invention do not require or prohibit the user of channel encryption (in-band or out-of-band) in order to provide heightened authentication of the user (e.g., two-factor authentication).

In accordance with at least some embodiments of the present invention, the first and second communication channels may be established simultaneously, via a common network interface or network port, but may be otherwise independent of one another. A user is allowed to access certain features and applications via, such as relatively lower security applications, via the first communication channel while simultaneously accessing other higher security applications via the second communication channel that required a higher level of authentication. This out-of-band capability to reach out to a user for stronger factor authentication can be used by any application seeking to perform two factor authentication with the user where such capability is not supported by the connecting protocol, application, or infrastructure of the first communication channel. Thus, a secure connection method is provided that substantially prevents replay attacks and ensures message integrity (i.e., because there are different communication channels used for the different levels of authentication).

Another method is provided that generally comprises:

establishing a first communication channel with a server;

responding to a first authentication request with at least one of a username and password;

accessing a first application on the server;

sending a request to the server to access a second application;

receiving a second authentication request from the server, wherein the second authentication request is received via a second communication channel that is different from the first communication channel; and

responding to the second authentication request with a message transmitted over the second communication channel.

These and other advantages will be apparent from the disclosure of the invention(s) contained herein. The above-described embodiments and configurations are neither complete nor exhaustive. As will be appreciated, other embodiments of the invention are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIG. 1 is a block diagram depicting a distributed communication system in accordance with embodiments of the present invention;

FIG. 2 is a block diagram depicting a data structure utilized in accordance with embodiments of the present invention; and

FIG. 3 is a signal diagram depicting a method of authenticating a user in accordance with embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any computing application in which it is desirable to maintain a certain level of security for applications contained within a particular device.

The exemplary systems and methods of this invention will also be described in relation to analysis software, modules, and associated analysis hardware. However, to avoid unnecessarily obscuring the present invention, the following description omits well-known structures, components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

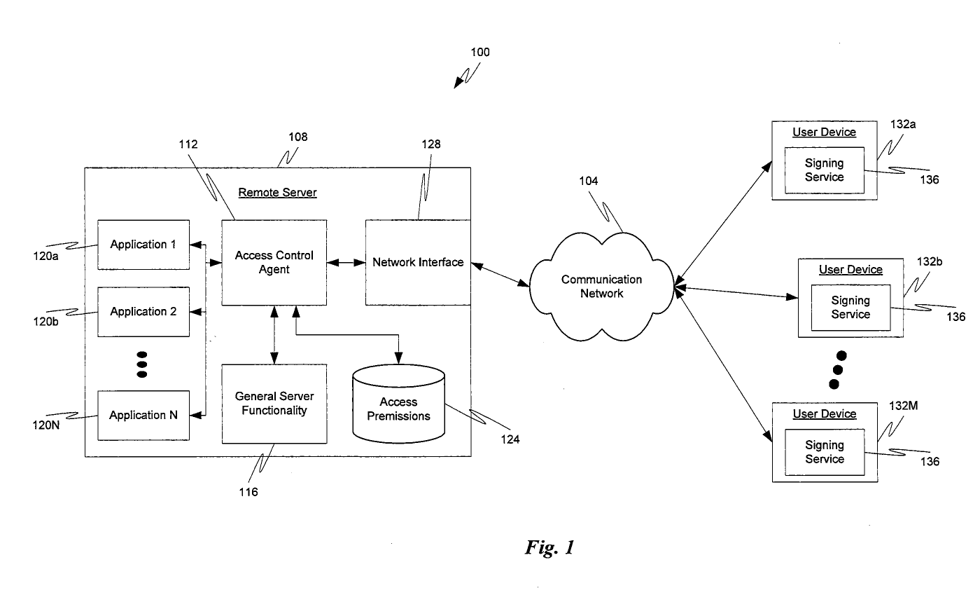

FIG. 1 shows an illustrative embodiment of a communication system 100 in accordance with at least some embodiments of the present invention. The communication system 100 may comprise a remote server 108 or similar type of remote processing device in communication with one or more user devices 132a-M via a communication network 104.

The communication network 104 may comprise any type of information transportation medium and may use any type of protocols to transport messages between endpoints. The communication network 104 may include wired and/or wireless communication technologies. Examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), the Internet, and any other type of packet-switched or circuit-switched network known in the art. In addition, it can be appreciated that the communication network 104 need not be limited to any one network type, and instead may be comprised of a number of different networks and/or network types.

The user devices 132a-M may be any type of communication device that is adapted to provide a user with the ability to access and communicate with the remote server 108. In accordance with at least one embodiment of the present invention, the user devices 132a-M may be adapted to utilize the Internet Protocol (IP) Suite (e.g., data packets) to establish and carry communications with the remote server 108 as well as other user devices 132. The user devices 132a-M may be commonly associated with a customer that either hosts or has paid for access to the remote server 108. Alternatively, one or more of the user devices 132a-M may be associated with different customers who are sharing the services provided by the remote server 108. As can be appreciated, the user devices 132a-M may be located at a common facility or different geographically separated facilities and may or may not be hosted by the same enterprise.

The remote server 108 may comprise a dedicated processor or collection of processors that function to provide services to client devices (e.g., user devices 132). Examples of such services include, but are not limited to, general server functionality 116 as well as any number of remote applications 120a-N. The general server functionality 116 may include a remote operating system or any other type of program/interface that allows a user to utilize the basic functionality of the remote server 108. The applications 120a-N, on the other hand, may include enhanced functionality and/or processing capabilities that can be provided to a user from the remote server 108.

Access to the server 108 functionality may be controlled by an access control agent 112. Alternatively, each application 120 may be adapted to enforce its own security provisions. In such an embodiment, the access control agent 112 is used to enforce the security provisions of the general server functionality 116.

The access control agent 112 may be adapted to reference access permissions 124 to determine what level of security is required for each service 116, 120 and what authentication measures a user has to comply with to utilize such services 116, 120. In accordance with at least some embodiments of the present invention, the security requirements of each service 116, 120 may differ depending upon the sensitivity of data and information utilized by the service 116, 120 and provided to the user device 132. Often times, applications 120 that provide a user access to sensitive data such as account information, passwords, and other confidential information may require a higher level of security than other applications 120 that only perform simple tasks as well as the general server functionality 116. If the user device 132 is requesting access to either the general server functionality 116 or one or more applications 120a-N, then the access control agent 112 will reference the access permissions 124 to determine what level of user authentication is required to before such access is allowed.

Access to an application 120 may be selectively and individually controlled for each user device 132. Thus, some user devices 132 may be allowed to access the first application 120a while others may not be allowed access to the first application 120a. Likewise, each user device 132 may be selectively and individually allowed access to each application 120. Thus, as an example, the first user device 132a may only be allowed to access the second application 120b and the Nth application 120N whereas the second user device 132b may only be allowed access to the first 120a and second 120b applications. Of course, such access may be predicated upon what user is utilizing a particular user device 132 as part of the security features may be predicated upon what a user knows (e.g., may be password controlled).

In accordance with at least some embodiments of the present invention, when a user device 132 requests access to an application 120 requiring a higher level of security than the general server functionality 116, then a separate connection may be established between the server 108 and user device 132 that is dedicated for use with the higher security application 120. As one example, an out-of-band socket may be utilized for the second communication channel to communicate with the higher security application 120.

In accordance with at least one embodiment of the present invention, the first connection between the remote server 108 and user device 132 may be any type of connection (e.g., hyper text transfer protocol (http), telnet, ftp, etc.) and may be a relatively insecure connection. The second connection used for the higher security application 120, on the other hand, may utilize TCP, UDP, SCTP, or any other type of transport layer protocol in the Internet Protocol Suite and may provide a higher level of security across the communication network 104 than the first connection.

Although the access permissions data store 124 is depicted as being separate from the access control agent 112, one skilled in the art will appreciate that the information maintained in the access permissions data store 124 may be maintained as a data structure within the access control agent 112 itself.

The remote server 108 may comprise a network interface 128 that serves as the physical interface between the remote server 108 and the communication network 104. Communications between the user devices 132 and the remote server 128 pass through the network interface 128 and are received at the access control agent 112. In accordance with at least some embodiments of the present invention, the network interface 128 may comprise a single communication port, such as a serial port or parallel port. Exemplary network interfaces 128 may include, but are not limited to, a PS/2 port, a Universal Serial Bus (USB) port, an RS-232 port, a Small Computer Systems Interface (SCSI) port, a T1 port, an Ethernet port, as well as any other type of wired or wireless communication interface known or yet to be developed.

The remote server 108 may comprise any type of processing medium operable to perform instructions stored on an electronic data storage area. The term “server” as used herein should be understood to include a PBX, an enterprise switch, an enterprise server such as a Unix server, or other type of telecommunications system switch or server, as well as other types of processor-based communication control devices such as media servers (i.e., email servers, voicemail servers, web servers, and the like), computers, adjuncts, etc.

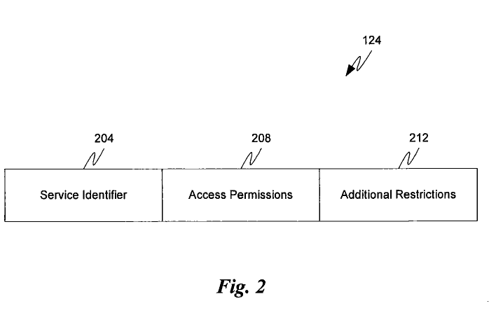

Referring now to FIG. 2, an exemplary data structure maintained by the access permissions data store 124 will be described in accordance with at least some embodiments of the present invention. The data structure may contain a plurality of data fields for helping determine whether a user is allowed to access a particular application 120 and what sort of authentication measures need to be taken to obtain such access. Examples of such data fields include, without limitation, a service identifier field 204, an access permissions field 208, and an additional restrictions field 212.

The service identifier field 204 may include data that identifies each of the services 116, 120 provided on the remote server 108. The service may be identified by an application name or number that is unique to the application 120 associated therewith or a generic identifier for the general server functionality 116.

The access permissions field 208 may include data that defines the authentication requirements for the application 120 associated therewith. As an example, a lower security application 120 may require a username and password to logon to the application 120. Thus, the username and password may be stored in the access permissions field 208. As another example, a higher security application 120 may require stronger authentication than a simple username and password (e.g., use of an electronic certificate, an electronic signature, and another password). The required authentication information may also be maintained in the access permissions field 208.

The additional restrictions field 212 may comprise access restriction data that supplements the data in the access permissions field 208. As one example, the additional restrictions field 212 may comprise identifiers of users and/or user devices 132 that are restricted from accessing a particular application 120. As another example, the additional restriction field 212 may comprise rule sets defining how long access to an application 120 can be maintained, particularly how long user inactivity will be tolerated until the second connection is automatically terminated.

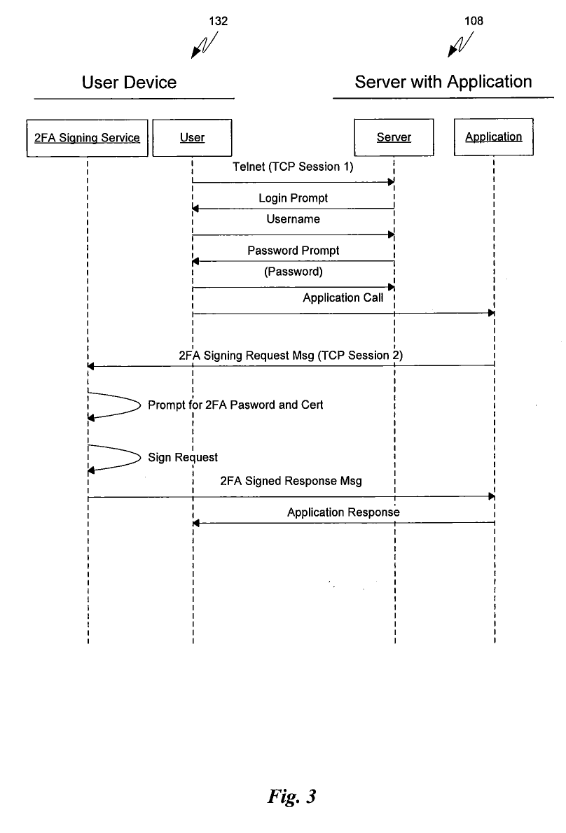

Referring now to FIG. 3, an authentication method will be described in accordance with at least some embodiments of the present invention. The method is initiated when the user device 132 attempts to initiate a first connection with the remote server 108. This may be in the form of an http request, for example, or a Telnet connection request as is shown in the FIG. 3. Depending upon the security measures associated with accessing the general server functionality 116, the server 108 responds to this request by sending the user device 132 a login prompt. A valid user will respond to this prompt with a username. The server 108 will also send the user device 132 a password prompt to which an authorized user will respond with a valid password.

After the username and password has been provided to the server 108, the user device 132 is allowed to directly utilize the general server functionality 116 and any lower security applications 120. If, however, the user device 132 attempts to utilize a higher security application 120, then the server 108 will open a second TCP (depicted), UDP (not depicted), or any other, perhaps previously-established, transport layer protocol connection from the server 108 to the user device 132 whereby it sends a message to the user device 132 which contains the security parameters of the high security application 120. A signing service 136 on the user device 132 listens on a listen port and receives the message from the server 108. In accordance with at least some embodiments of the present invention, the signing service 136 may comprise an application running on the user device 132 that is adapted to read sensitive data (e.g., keys, passwords, etc.) from a portable credential carried by the user and plugged in as a peripheral device or read wirelessly by the user device 132. Alternatively, the signing service 136 may be totally executed by the portable credential that is carried by the user (e.g., a smart card or the like). This portable credential may be plugged into the user device 132 or communicate via some other known mechanism with the user device 132. The signing service 136 may be adapted to act independent of the user device 132 and may request additional user input. For instance, the signing service 136 may require that the user input a valid password or swipe their finger across a biometric reader before the signing service 136 is allowed to review the message and process the message.

Upon receiving the message, the signing service 136 takes the received message, time stamps it, and presents the message to the user and requests that the user digitally sign the message with their certificate's private key, which may be stored on a smart card or the like (i.e., something that the user possesses). In one embodiment of the present invention, the contents of the signing request message may be presented to the user in a human-perceptible format whereby the user is asked to approve that the message be processed before they are prompted for their password which would allow their smart card (or other certificate key store (e.g., key fob, USB memory device, etc.) is used to sign the message.

Once the connection has been approved by the user (e.g., the user has entered a password for their smartcard to activate said smart card), the signing service 136 on the user device 132 digitally signs the message and returns the signed and stamped message to the high security application 120. This return message is transmitted to the remote server 108 via the second communication path (i.e., the out-of-band socket). As can be appreciated either the high security application 120 itself and/or the access control agent 112 may analyze the received message to determine if the user is allowed to utilize the high security application 120. During the analysis step, the application 120 or access control agent 112 validates that the message has been digitally signed, verifies the time stamp, and proceeds to execute the application 120 with the parameters originally specified by the user to the application 120. Thus, the application 120 has authenticated the user by certificate (through the additional TCP connection) even though the user has already authenticated themselves with the remote server 108 via a simple username and password.

Embodiments of the present invention may apply to a wide variety of transaction that require two-person or “oversight” authentication and/or authorization, similar to the missile key approach used by the military for launching certain weapons. Investment banks, hedge funds, and the like may be possible users of such a system to ensure that large trades or investments cannot be made in isolation by a rogue employee.

In another situation, there may be an application 120 that a company wants to protect such that users of the application 120 must first get authorization from an administrator. In this instance, when the user attempts to access the secured application 120, the administrator is notified via the out-of-band communication and must first grant access before the user is allowed to connect with the application 120.

Embodiments of the present invention may also be applied at the consumer level to jointly held resources, such as a joint checking account. Not only would it provide a check and balance system to verify that changes to the joint account are mutually agreed upon, but it could also potentially make it more difficult for a thief to steal a person's identity and attempt an electronic withdrawal from that account.

There may be a number of modifications to the above-described functionality of the remote server 108, application 120, and/or user device 132 without departing from the scope of the present invention. One such alternative embodiment may include requiring that a certificate used to authenticate via the second communication channel is issued from an authorized certificate authority. This requirement may be enforced in addition to the digital signature, password, and time stamp checks performed for higher security applications 120.

In another alternative embodiment, two forms of identification may need to be presented to the signing service 136 to dually sign the message before it is sent back to the application 120. The two forms of identification may include a smart card and a credit card each of which may be used as a separate electronic certificate (i.e., the form factor that carries the private key(s) used for authentication with higher security applications 120) that is required during electronic check out during use of a web-based application (i.e., during checkout from a web retailer). The user may present their credit card to the signing service 136 first where its necessary information is read. Then the user may present their smart card or other form of identification to the signing service 136 to further verify their identity. Thus, both the credit card and smart card may be adapted to sign the message before it is sent back to the application 108.

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a server, personal computer, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The analysis systems, methods and protocols illustrated herein can be readily implemented in hardware and/or software using any known or later developed systems or structures, devices and/or software by those of ordinary skill in the applicable art from the functional description provided herein and with a general basic knowledge of the communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for authenticating users with out-of-band messaging has been provided. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A communication method, comprising:
establishing a first communication channel between a server and a user device;
performing a first authentication of the user device at the server;
in response to performing the first authentication, allowing the user device to access general functionality of the server;
receiving a request from the user device to access an application on the server;
creating a second communication channel between the server and at least the user device; and
sending a second authentication request to the user device via the second communication channel.

2. The method of claim 1, further comprising:
receiving a response to the second authentication request from the user device via the second communication channel;
analyzing the response to the second authentication request; and
determining whether the user device is allowed to access the application based on results of the analysis.

3. The method of claim 2, wherein analyzing comprises determining whether the response includes at least one of a valid electronic signature from the user device, a valid time stamp, and a valid key.

4. The method of claim 1, wherein the second communication channel is established through an out-of-band socket and wherein communications on the second communication channel utilize at least one of a Transmission Control Protocol and a User Datagram Protocol.

5. The method of claim 1, wherein the first authentication requires one factor authentication and wherein the second authentication requires at least one of two factor authentication and biometric authentication.

6. The method of claim 5, wherein the server further comprises a second application, wherein the application is a high security application, wherein the second application is a low security application, wherein the user device is allowed access to the second application after the first authentication is performed, and wherein the user device is not allowed access to the application until a valid response to the second authentication request is received at the server.

7. A computer readable medium comprising processor executable instructions that, when executed, perform the steps of claim 1.

8. A communication device, comprising:
a first application comprising a first required level of security;
a second application comprising a second required level of security, wherein the first and second required levels of security are different, wherein a user device is allowed access to the first application only after a valid response is received from the user device to a first authentication request sent over a first communication channel established with the user device, and wherein the user device is allowed access to the second application only after a valid response is received from the user device to a second authentication request sent over a second communication channel established with the user device, wherein the first and second communication channels are established with the user device at substantially the same time.

9. The communication device of claim 8, wherein the second communication channel comprises a message exchange that is out-of-band from the first communication channel.

10. The communication device of claim 8, wherein a valid response to the second authentication request comprises receiving at least one of at least one of a valid electronic signature from the user device, a valid time stamp, and a valid key.

11. The communication device of claim 8, wherein communications on the second communication channel utilize at least one of a Transmission Control Protocol and a User Datagram Protocol.

12. The communication device of claim 8, wherein the first authentication requires one factor authentication and wherein the second authentication requires at least one of two factor authentication and biometric authentication.

13. The communication device of claim 12, wherein the second authentication requires verification of something that a user associated with the user device knows and something that the user has.

14. The communication device of claim 8, wherein the first application is a low security application, wherein the second application is a high security application, wherein the user device is allowed access to the first application and not the second application after a valid response to the first authentication request has been received and a valid response to the second authentication request has not been received.

15. A communication method, comprising:
establishing a first communication channel with a server;
responding to a first authentication request with at least one of a username and password;
accessing a first application on the server;
sending a request to the server to access a second application;
receiving a second authentication request from the server, wherein the second authentication request is received via a second communication channel that is different from the first communication channel; and
responding to the second authentication request with a message transmitted over the second communication channel.

16. The method of claim 15, wherein the message transmitted over the second communication channel as a response to the second authentication request comprises at least one of an electronic signature, a time stamp, and a key.

17. The method of claim 15, further comprising:
time stamping the second authentication request;
prompting a user for at least one of a password and a certificate;
receiving at least one of a password and information from the certificate;
signing the second authentication request; and
sending the signed second authentication request with the message transmitted over the second communication channel.

18. The method of claim 15, wherein the communications on the second communication channel utilize at least one of a Transmission Control Protocol and a User Datagram Protocol.

19. The method of claim 15, wherein the second communication channel comprises a message exchange that is out-of-band from the first communication channel and wherein the first and second communication channels exist at substantially the same time.

20. The method of claim 15, wherein the first and second applications comprise different security requirements, the method further comprising accessing both the first and second applications at substantially the same time.
